(19) United States
(12) Patent Application Publication
(10) Pub. No.: US 2010/0287051 A1
(43) Pub. Date: Nov. 11, 2010

(54) SYSTEM AND METHOD OF CREATING A USER CUSTOMIZED INTERNET EXPERIENCE

(75) Inventor: Leigh M. Rothschild, Sunny Isles Beach, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 2022, BOCA RATON, FL, 33487, US

(73) Assignee: LMR INVENTIONS, LLC, Sunny Isles Beach, FL (US)

(21) Appl. No.: 12/775,951

(22) Filed: May 7, 2010

Related U.S. Application Data
(60) Provisional application No. 61/176,127, filed on May 7, 2009.

(51) Int. Cl. G06Q 30/00

(52) U.S. Cl. 705/14.63; 705/14.62

(57) ABSTRACT

Embodiments of the invention provide for a content delivery method for advertising content in a vehicle. The method includes retrieving a profile of an end user operating a vehicle and determining a selection of content for wireless delivery to a playback device disposed in the vehicle according to the retrieved profile. The method also includes identifying advertising content corresponding to the retrieved profile, and transmitting the identified advertising content and the selection of content for alternating playback in the playback device disposed in the vehicle.

### CROSS-REFERENCE TO RELATED APPLICATIONS

This patent application claims the benefit under 35 U.S.C. § 120 to presently pending U.S. Provisional Patent Application 61/176,127, filed on May 7, 2009 entitled SYSTEM AND METHOD OF CREATING A USER CUSTOMIZED INTERNET EXPERIENCE, and also to presently pending U.S. Provisional Patent Application 61/174,794, filed on May 1, 2009 entitled SYSTEM AND METHOD OF RECEIVING AND DISTRIBUTING ADVERTISING SPONSORED DIGITAL CONTENT ON A DEMAND BASIS TO A WIRELESS MOBILE DEVICE, the entire teachings of which are incorporated herein by reference.

### BACKGROUND OF THE INVENTION

1. Field of the Invention

The present invention relates to the field of content distribution over the Internet, and more particularly to customized content delivery over the Internet.

2. Description of the Related Art

Digital media is increasingly becoming the source for media for most users around the world. Music and video are distributed on a paid basis or on a free basis. Another trend is that music and video are increasingly utilized on mobile devices that the user takes with him from place to place. These mobile devices use memory to store the digital media, or these mobile devices receive the media via communications channels including satellite communications channels. In both cases (memory or communications channels) these mobile devices can be used in vehicles such as boats, automobiles, trains, and airplanes. Further, both types of mobile devices are frequently integrated into the vehicle at the time of purchase of the vehicle.

These mobile devices allow the user to receive music and video files that have been pre-stored in the mobile device memory, or that are transmitted/streamed by the broadcaster. In the case of the first model (memory) the user is limited to only the source material that has been provided in memory. In the case of the second model (broadcast) the user is limited to only what the broadcaster transmits. In the case of on-demand music distribution services, the end user can request playback of a specific artist or music type, but the service will not stream/transmit a specific request for a selection by a specific artist. Further, the streaming media services are not structured for use in a mobile environment and particularly a mobile environment where the user cannot freely interact with a keyboard such as an automobile or boat or airplane.

### BRIEF SUMMARY OF THE INVENTION

Embodiments of the invention provide for a system and method of selecting digital media content and advertising content for delivery to a user over the Internet based upon psychographic, demographic and other information present in a profile of the user. In an aspect of the embodiments, the content can be streamed or transmitted to a wireless mobile device for playback and/or display for the user. Specifically, the method includes retrieving a profile of an end user operating a vehicle and receiving a selection of content for wireless delivery to a playback device disposed in the vehicle. The method also includes identifying advertising content corresponding to the retrieved profile, and transmitting the identified advertising content and the selection of content for playback in the playback device disposed in the vehicle.

### BRIEF DESCRIPTION OF THE SEVERAL VIEWS OF THE DRAWINGS

FIG. 1 is a schematic illustration of an content streaming system for mobile devices; and,

FIG. 2 is a flow chart illustrating a process for content streaming to mobile devices.

### DETAILED DESCRIPTION OF THE EMBODIMENTS OF THE INVENTION

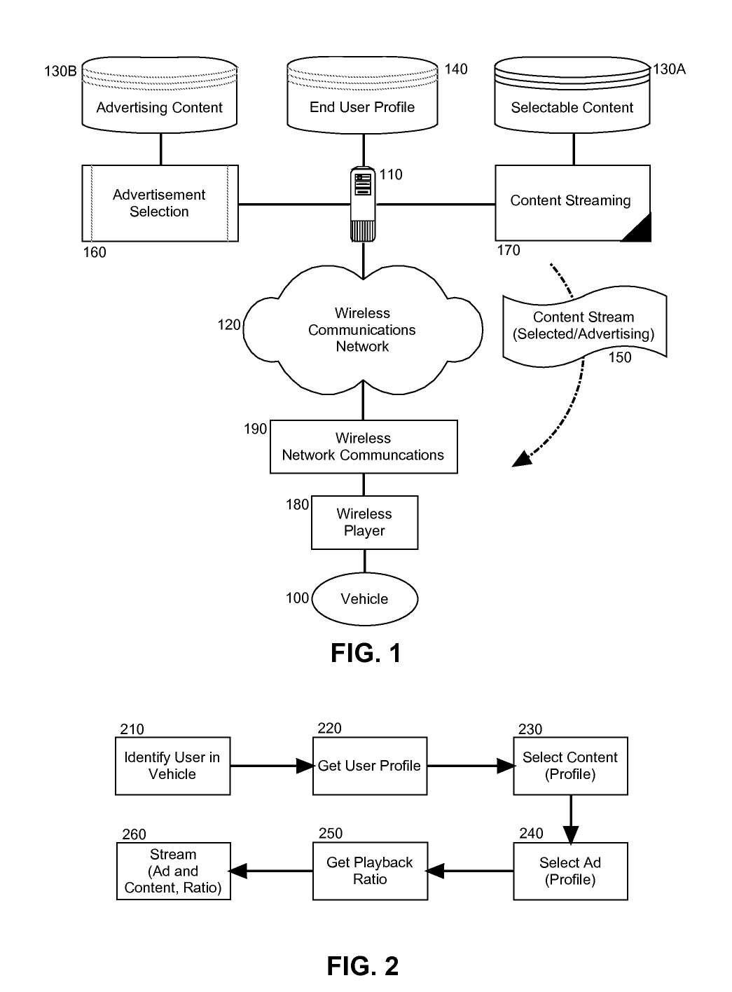

FIG. 1 is a schematic illustration of an advertisement streaming system for mobile devices. By way of example, an end user drives an automobile 100 and wishes to listen to a specific music selection. The end user has a wireless network communications capable vehicle and has a “wireless network communications” 190 enabled device 180 installed in the vehicle 100 such as a “Wi-MAX” or “Wi-Fi” capable device. The wireless network communications capable device 180 alternatively can be a satellite or cellular device (often referred to as a “wireless WAN” device. The end user has a profile of registered demographic and other pertinent information for the selected “wireless network communications” service at the Web site for the service. Registration questions include but are not limited to name, address, age, email address, texting address, gender, education, and music and video preferences. The registration can be achieved through a remote server (remote from the vehicle) or from within the vehicle itself

The end user now activates the wireless network communications player 180 device and directs the wireless network communications player 180 to a specific Internet Protocol (IP) address of a selected media service. To direct the wireless network communications player 180, the end user in the vehicle 100 can use voice commands, biometrics, or keyboard user input, to provide the device the identity of the user. The identity of the end user is important since multiple users may be using the wireless network communications player. The identity of the end user is now sent via wireless network communications (or other communications channels) to a remote server 110 where this information is submitted to a database 140 to resolve the identity of the end user.

Content streaming module 170 can select audio or video content consistent from a data store of selectable content 130A according to a profile of the end user that sets forth demographic and psychographic data for the end user. Optionally, the selected content 130A can include a mixture of audio or video content automatically selected according to the profile and audio or video content selected directly by the end user. Further, advertisement selection module 160 can map the music preferences of the end user to the identified end user in the database 140 and demographic data pertaining to the end user can be consulted to determine advertising in an advertisement content data base 130B best suited and most effective for the end user. In an aspect of the embodiment, location based data such as a position of the vehicle 100 acquired by a global positioning system (GPS) receiver can be provided to the remote server 110. The position of the vehicle 100 further can be factored into determining advertising best suited and most effective for the end user. Both 150 can be transmitted to the wireless network communications player 180 in the vehicle 100 over the wireless communications network 120.

In further illustration, FIG. 2 is a flow chart illustrating a process for advertisement streaming to mobile devices. Beginning in block 210, the user in the vehicle can be identified. In block 220, a user profile of the user can be retrieved and in block 230 a content selection according to the profile can be determined. In block 240, advertisement content consistent with the user profile also can be selected. In block 250, a playback ratio can be determined and in block 260, the advertisement content and the selected content can be streamed to the end user in the vehicle according to the playback ratio.

I claim:

1. A content delivery method for advertising content in a vehicle comprising:
retrieving a profile of an end user operating a vehicle;
determining a selection of content for wireless delivery to a playback device disposed in the vehicle according to the retrieved profile;
identifying advertising content corresponding to the retrieved profile; and,
transmitting the identified advertising content and the selection of content for playback in the playback device disposed in the vehicle.

2. The method of claim 1, wherein transmitting the identified advertising content and the selection of content for playback in the playback device disposed in the vehicle, comprises transmitting the identified advertising content and the selection of content for alternating playback in the playback device disposed in the vehicle according to a determined ratio of alternating playback of user selected content and advertising content.

3. The method according to claim 1, wherein transmitting the identified advertising content and the selection of content for playback in the playback device disposed in the vehicle, comprises transmitting the identified advertising content and the selection of content and also a user specified content for playback in the playback device disposed in the vehicle

4. The method of claim 2, wherein the ratio is dependent upon a profile of a trip specified for the vehicle.

5. The method of claim 2, wherein the advertising content is additionally selected according to a current position of the vehicle as reported by the vehicle.
